(19) United States
(12) Patent Application Publication
(10) Pub. No.: US 2018/0222385 A1
(43) Pub. Date: Aug. 9, 2018

(54) HEADS-UP DISPLAY WITH POINT OF DISPLAY AUDIO ALERT CAPABILITY

(71) Applicant: FORD GLOBAL TECHNOLOGIES, LLC, Dearborn, MI (US)

(72) Inventor: Matthew Anthony Majkowski, Dearborn, MI (US)

(21) Appl. No.: 15/428,348

(22) Filed: Feb. 9, 2017

(51) Int. Cl. B60Q 9/00; H04R 17/00; H04R 7/04; G02B 27/01

(52) U.S. Cl. CPC B60Q 9/00; H04R 17/00; H04R 7/04; G02B 2027/014; H04R 2499/13; H04R 2307/025; G02B 27/0101

(57) ABSTRACT

A heads-up display includes a transparent speaker diaphragm and an image projector oriented to project an image onto the transparent speaker diaphragm. The heads-up display has the capability of providing visual data and an audio alert from a single point source.

### TECHNICAL FIELD

This document relates generally to the motor vehicle equipment field and, more particularly, to a heads-up display having point of display audio alert capability.

### BACKGROUND

A heads-up display (HUD) is a transparent display that presents data without the user, in this case the driver of a motor vehicle, having to divert attention from a normal operating viewpoint of the motor vehicle through the front windshield.

This document relates to a new and improved heads-up display incorporating a transparent speaker diaphragm upon which data or an image is projected. Advantageously, this new and improved heads-up display has the capability of generating an audio alert at the point of the display so as to naturally draw the attention of the motor vehicle operator to the display when an important image or data is being projected thereon.

### SUMMARY

In accordance with the benefits and advantages described herein, a new and improved heads-up display is provided. That heads-up display comprises a transparent speaker diaphragm and an image projector oriented to project an image onto that transparent speaker diaphragm.

The heads-up display also includes an actuator for driving the transparent speaker diaphragm so as to generate sound. In at least one of many possible embodiments, the transparent speaker diaphragm is made from an acrylic sheet and the actuator is a piezoelectric actuator. Further, the heads-up display includes a controller configured to control the image projected and in some of the many possible embodiments, the actuator for driving a transparent speaker diaphragm.

In accordance with an additional aspect, a method of providing a heads-up display comprises projecting an image onto a transparent speaker diaphragm. That method may include the step of driving a transparent speaker diaphragm with an actuator whereby the transparent speaker diaphragm produces sound. In addition, the method may include alerting an individual to the image projected onto the transparent speaker diaphragm by generating an audio alert through the speaker diaphragm.

The method may include the step of mounting the transparent speaker diaphragm onto a support surface inside a motor vehicle. More specifically, the method may include the step of mounting a transparent speaker diaphragm onto a dashboard of the motor vehicle.

Still further, the method includes displaying the image on the transparent speaker diaphragm.

In some of the many possible embodiments, the method may include using a clear acrylic sheet as the transparent speaker diaphragm. Further, the method may include using a piezoelectric actuator to generate sound from the clear acrylic sheet.

In the following description, there are shown and described several preferred embodiments of the heads-up display as well as the method of providing a heads-up display. As it should be realized, the heads-up display and the related method are capable of other, different embodiments and their several details are capable of modification in various, obvious aspects all without departing from the heads-up display and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the heads-up display and method and together with the description serve to explain certain principles thereof.

FIG. 1 is a schematic representation of the heads-up display.

FIG. 2 is a similar schematic representation of the heads-up display from the visual perspective of a driver of a motor vehicle looking out through the windshield over the dashboard.

FIG. 3 is a schematic block diagram of one possible embodiment of the controller for the heads-up display illustrated in FIGS. 1 and 2.

Reference will now be made in detail to the present preferred embodiments of the heads-up display illustrated in the accompanying drawing figures.

### DETAILED DESCRIPTION

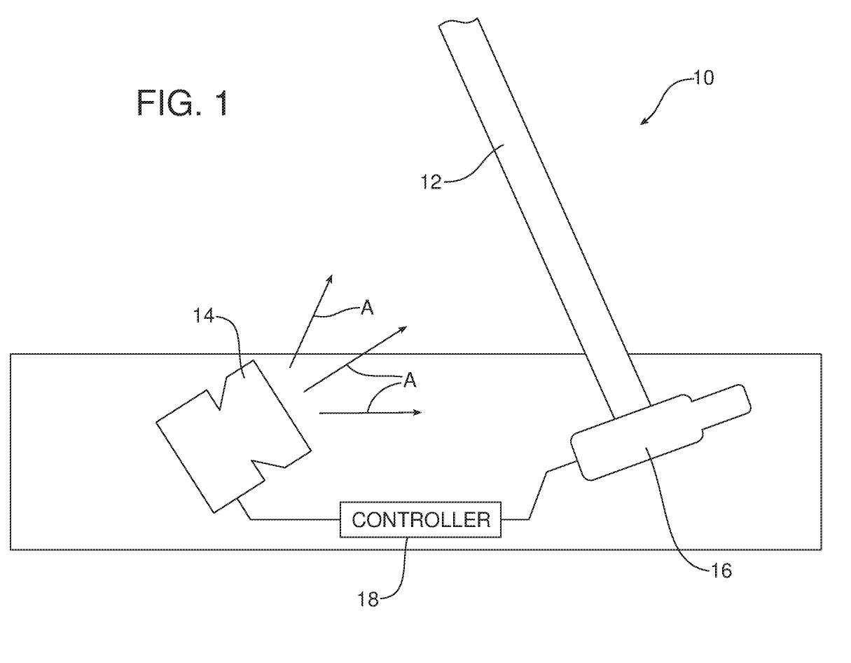

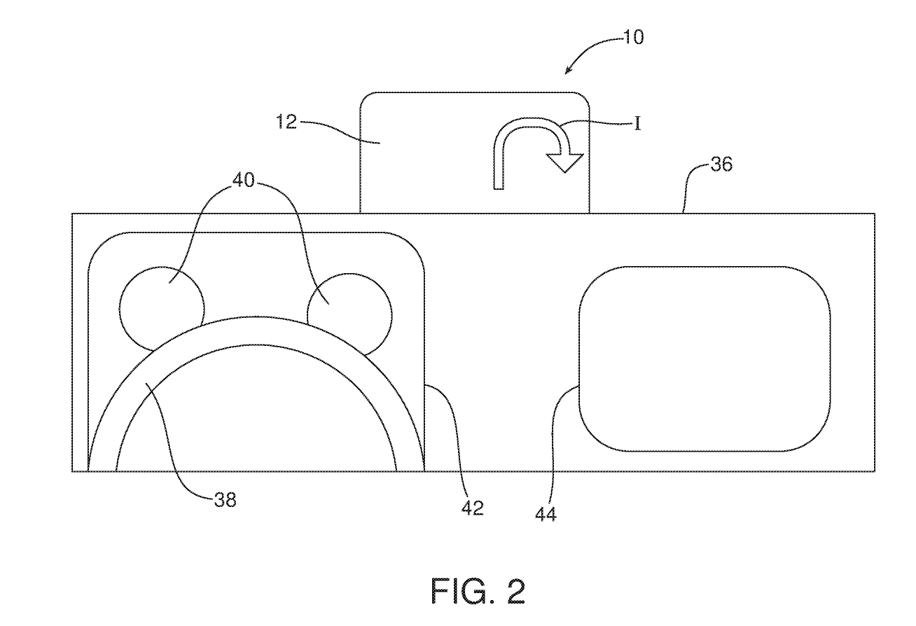

Reference is now made to FIGS. 1 and 2 illustrating one possible embodiment of the new and improved heads-up display 10. That heads-up display 10 includes a transparent speaker diaphragm 12 and an image projector 14 oriented to project an image onto the transparent speaker diaphragm (note action arrows A). As should be appreciated from the following description, the transparent speaker diaphragm 12 provides dual functionality as a sound generating speaker and a display screen for the projected image I. Thus, the transparent speaker diaphragm 12 provides one point visual imaging and sound generation.

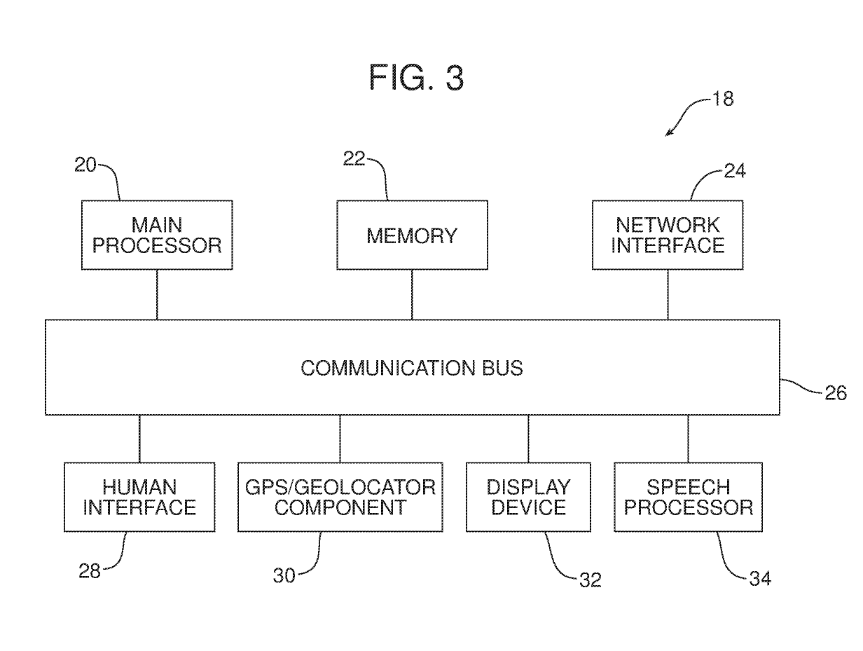

As illustrated in FIG. 1, the heads-up display 10 also includes an actuator 16 for driving the transparent speaker diaphragm 12 and generating sound. In one of many possible embodiments of the heads-up display, the transparent speaker diaphragm 12 may be formed by a sheet of optically clear acrylic glass material and the actuator 16 may comprise a piezoelectric actuator that stimulates the side of the transparent speaker diaphragm to generate the desired sounds. As further illustrated in FIG. 1, the heads-up display 10 also includes a controller 18. The controller 18 may comprise a computing device such as a dedicated microprocessor or electronic control unit (ECU) operating in accordance with appropriate operating instructions from control software. Thus, as illustrated in FIG. 3, the controller 18 may include one or more processors 20, one or more memories 22 and one or more network interfaces 24 all communicating with each other over a communication bus 26.

In some embodiments, the controller 18 may comprise a body control module or BCM which further includes a human interface 28, a GPS/geolocator component 30, a display device such as a multi-function display with touchscreen capability 32 and a speech processor 34 that also communicate with the other components of the controller 18 over the communication bus 26. As should be appreciated, the speech processor 34 provides the controller 18 with “voice command” capability.

In some embodiments, a BCM controller 18 performs a number of interior body electrically-based functions including, for example, interior locking, remote key entry, interior lighting, exterior lighting, windshield wiper control and the like. In some embodiments, the BCM controller 18 may also function to control entertainment functions (e.g. radio, CD player) and communications such as telephone and internet communications over a wireless network. In some embodiments, the BCM controller 18 is connected by a communication bus (not shown) to other control modules that provide one or more of these additional functions. Significantly, the BCM controller 18 is connected to a communication area network or CAN that provides data from virtually every operating system of the motor vehicle as well as news, information and data from remote locations via a wireless network. Any or all of this information may be displayed on the transparent speaker diaphragm 12 of the heads-up display 10 as desired by the motor vehicle operator. That motor vehicle operator may program the controller 18 for the display of desired information via the human interface 28, the touchscreen display device 32 or even via voice command through the speech processor 34.

Thus, as should be appreciated, the controller 18 may be configured to control the image projector 14 and, therefore, the image, including data, projected upon the transparent speaker diaphragm 12 for visual presentation to the driver or other individual in the motor vehicle. In addition, the controller 18 may be configured to control the actuator 16 for driving the transparent speaker diaphragm 12 and producing sound.

Consistent with the above description, a method is disclosed for providing a heads-up display 10. That method may be broadly described as comprising the step of projecting an image I onto a transparent speaker diaphragm 12 (see particularly FIG. 2). That transparent speaker diaphragm 12 may be mounted onto a support surface inside the motor vehicle such as the dashboard 36 illustrated in FIG. 2. As illustrated in FIG. 2, the transparent speaker diaphragm is offset from the steering wheel 38 and the instrument gauges 40 so as to at least partially extend between the instrument panel 42 and the center stack 44. Here it should be appreciated that the exact positioning of the transparent speaker diaphragm 12 on the dashboard 36 shown in FIG. 2 is for purposes for illustration alone and is not in any way limiting in scope. For example, the transparent speaker diaphragm 12 of the heads-up display 10 could be mounted on the dashboard 36 behind the windshield (not shown) but directly in line above the steering wheel 38 and the instrument panel 42 or in any other appropriate position including behind the windshield and directly above and aligned with the center stack 44.

The method may also include the step of driving the transparent speaker diaphragm 12 with an actuator 16 whereby the transparent speaker diaphragm produces the desired sounds. As a result, it should be appreciated that the method may include the step of alerting an individual to the image I projected onto the transparent speaker diaphragm 12 by generating an audio alert through the speaker diaphragm. As the audio alert is generated through the transparent speaker diaphragm 12, which also serves as the point of image projection, it should be appreciated that the audio naturally draws the attention of the driver to the image I.

The controller 18 may be selectively programmed by the vehicle operator through, for example, the touchscreen display device 32 or via voice command through the speech processor 34 to provide select audio alerts for images I including, but not limited to, particular data of interest. Thus, for example, an audio alert may be provided when the ambient temperature falls below a predetermined value as a warning regarding potential icy road conditions. Toward this end, the audio alert is sounded and the motor vehicle driver's attention is directed to the transparent speaker diaphragm 12 which displays an image of the ambient temperature.

As another example, the audio alert may be generated through the transparent speaker diaphragm 12 when the motor vehicle is being operated at a speed that exceeds the posted speed limit by a predetermined value while that information is displayed on the transparent speaker diaphragm via image I. As should be appreciated, the posted road speed limit for any particular road may be stored in the memory of the controller 18 for any particular location of the motor vehicle as currently determined by means of the GPS/geolocator component 30.

As should be appreciated, these are just two of the many potential audio alerts that may be provided by the heads-up display 10. In order to provide an audio distinction between a temperature alert, a speed limit alert or another alert for a different purpose, it should be appreciated that each type of audio alert may be associated with its own distinct sound. In case of any particular alert, the audio alert and image are broadcast from a single point: that is, the speaker diaphragm 12 of the heads-up display 10.

From the previous description, it should also be appreciated that the method may include the step of displaying the image I on the transparent speaker diaphragm 12. Further, the method may include using a clear acrylic sheet as the transparent speaker diaphragm 12 and using a piezoelectric actuator 16 to generate sound from the clear acrylic sheet.

As should be appreciated, the new and improved heads-up display 10 provides a number of benefits and advantages. The heads-up display uses an image projector 14 to project an image I onto a transparent speaker diaphragm 12 thereby providing an integrated visual and audio single point source. The actuator 16 and transparent speaker diaphragm 12 may be utilized as a dedicated audio alert system for the heads-up display. Alternatively, the transparent speaker diaphragm 12 and actuator 16 may be utilized as part of the entertainment speaker system of the motor vehicle thereby making a separate speaker redundant and unnecessary and enhancing options for the packaging and styling of the interior of the motor vehicle.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A heads-up display, comprising:
a transparent speaker diaphragm;
an image projector oriented to project an image onto said transparent speaker diaphragm;
an actuator for driving said transparent speaker diaphragm; and
a controller configured to control said image projector and said actuator.

2. (canceled)

3. (canceled)

4. (canceled)

5. The heads-up display of claim 1, wherein said transparent speaker diaphragm is made from an acrylic sheet.

6. The heads-up display of claim 5, wherein said actuator is a piezoelectric actuator.

7. A method of providing a heads-up display, comprising:
mounting a transparent speaker diaphragm onto a support surface inside a motor vehicle; and
projecting an image onto the transparent speaker diaphragm.

8. The method of claim 7, including driving said transparent speaker diaphragm with an actuator whereby said transparent speaker diaphragm produces sound.

9. The method of claim 8, including alerting an individual to the image projected onto said transparent speaker diaphragm by generating an audio alert through said transparent speaker diaphragm.

10. (canceled)

11. The method of claim 9, wherein the support surface is a dashboard of all the motor vehicle.

12. The method of claim 9, including displaying said image on said transparent speaker diaphragm.

13. The method of claim 12, including using a clear acrylic sheet as said transparent speaker diaphragm.

14. The method of claim 13, including using a piezoelectric actuator to generate sound from said clear acrylic sheet.

15. The method of claim 7, including using a clear acrylic sheet as said transparent speaker diaphragm.

16. The method of claim 15, including using a piezoelectric actuator to generate sound from said clear acrylic sheet.

17. The method of claim 16, including alerting an individual to the image projected onto the clear acrylic sheet by generating an audio alert through said clear acrylic sheet.
